(19) United States
(12) Patent Application Publication
(10) Pub. No.: US 2017/0161871 A1
(43) Pub. Date: Jun. 8, 2017

(54) METHOD AND ELECTRONIC DEVICE FOR PREVIEWING PICTURE ON INTELLIGENT TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Zhi Chen, Beijing (CN)

(21) Appl. No.: 15/243,543

(22) Filed: Aug. 22, 2016

Related U.S. Application Data
(63) Continuation of application No. PCT/CN2016/088958, filed on Jul. 6, 2016.

(30) Foreign Application Priority Data
Dec. 8, 2015 (CN) 201510897018.0

(51) Int. Cl. G06T 3/40; G06T 1/60; G06K 9/46; G06K 9/52; G06K 9/62

(52) U.S. Cl. CPC G06T 3/40; G06K 9/52; G06K 9/6267; G06K 9/4604; G06T 1/60

(57) ABSTRACT

A method for previewing a picture on an intelligent terminal, comprising: acquiring a picture to be previewed, and identifying a picture type; acquiring the size of a picture preview window if the picture type is an odd-shaped picture; determining a zooming parameter for the odd-shaped picture according to the size of a short edge of the odd-shaped picture and the size of a corresponding edge of the picture preview window; and zooming and displaying the odd-shaped picture in the picture preview window according to the zooming parameter.

### CROSS-REFERENCE TO RELATED APPLICATIONS

The present application is a continuation of a PCT application with an Application No. PCT/CN2016/088958, filed on Jul. 6, 2016, which claims priority to Chinese patent application No. 201510897018.0, filed on Dec. 8, 2015, entitled “METHOD AND APPARATUS FOR PREVIEWING PICTURE ON INTELLIGENT TERMINAL”, the entire contents of which are incorporated herein by reference.

### TECHNICAL FIELD

The present application relates to the picture processing technologies for an intelligent terminal, and in particular, to a method and an electronic device for previewing a picture on an intelligent terminal.

### BACKGROUND

With the continuous development of communication technologies, media information such as picture, music and video bring an excellent audio-visual experience to a user, and become one of the important component parts of mobile intelligent terminal systems.

Picture is a multimedia resource that is most frequently concerned by an intelligent terminal user. To improve the picture content effect and increase the information volume, the contents of network information are often present in a form of a long picture. In the case that a long picture is viewed in a preview mode in the operating system or application software of the intelligent terminal, FIG. 1 is a diagram showing the default preview effect of a long picture in an application software in the prior art. As shown in FIG. 1, when a long picture is opened in a preview window, all the contents are presented simultaneously by default. Because at this point, the character and the picture size in the long picture are both too small, a user needs to zoom in the long picture by a gesture operation or by clicking a zoom-in virtual key.

However, in the above long picture content reading mode of the prior art, a complete accuracy cannot be realized via the gesture operation of a user, and an excessive zoom-in operation is done so that the long picture presented on a preview window needs to be adjusted left and right to read the picture content, or the content presented on the preview window after the zoom-in operation of the long picture is not the part that the user wants to read, and thus the user needs to adjust the long picture presented on the preview window up and down or left and right, which may cause a poor reading experience to a user.

### SUMMARY

The application provides a method and an electronic device for previewing a picture on an intelligent terminal, thereby improving the readability of a picture.

In a first aspect, embodiments of the application provide a method for previewing a picture on an intelligent terminal, which includes:

acquiring a picture to be previewed, and identifying a picture type;

acquiring the size of a picture preview window if the picture type is an odd-shaped picture;

determining a zooming parameter for the odd-shaped picture according to the size of a short edge of the odd-shaped picture and the size of a corresponding edge of the picture preview window; and

zooming and displaying the odd-shaped picture in the picture preview window according to the zooming parameter.

In a second aspect, embodiments of the application further provide a non-transitory computer storage medium storing computer-executable instructions that, when executed by an electronic device, cause the electronic device to execute the above methods for previewing a picture on an intelligent terminal according to the application.

In a third aspect, embodiments of the application further provide an electronic device, which includes: at least one processor; and, a memory communicably connected with the at least one processor for storing instructions executable by the at least one processor, wherein execution of the instructions by the at least one processor causes the at least one processor to execute the above methods for previewing a picture on an intelligent terminal according to the application.

### BRIEF DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a diagram showing a default preview effect of a long picture in an application software in the prior art;

FIG. 2A is a schematic flow chart of a method for previewing a picture on an intelligent terminal according to Embodiment 1 of the application;

FIG. 2B is a diagram showing the preview effect of an odd-shaped picture according to Embodiment 1 of the application;

FIG. 3 is a schematic flow chart of a method for previewing a picture on an intelligent terminal according to Embodiment 2 of the application;

FIG. 4 is a structural representation of an apparatus for previewing a picture on an intelligent terminal according to Embodiment 3 of the application; and

FIG. 5 is a schematic diagram showing the hardware structure of an electronic device for executing a method for previewing a picture on an intelligent terminal according to Embodiment 5 of the application.

### DETAILED DESCRIPTION

The application will be illustrated in detail in conjunction with the drawings and embodiments. It may be understood that, the embodiments described here are only set for explaining, rather than limiting, the application. Additionally, it further needs to be noted that, for convenient description, the drawings only show the parts related to the application, rather than the whole contents. Before discussing the exemplary embodiments in more detail, it should be noted that some exemplary embodiments are described as processes or methods depicted by a flow chart. Although a plurality of operations (or steps) are described as sequential processes in the flow chart, many operations therein may be implemented parallelly, concurrently or simultaneously. In addition, the operation sequence may be rearranged. When the operations are completed, the process may be terminated; however, it may further include additional steps that are not included in the drawings. The process may correspond to a method, a method, a function, a procedure, a subroutine and a subprogram, etc.

### Embodiment 1

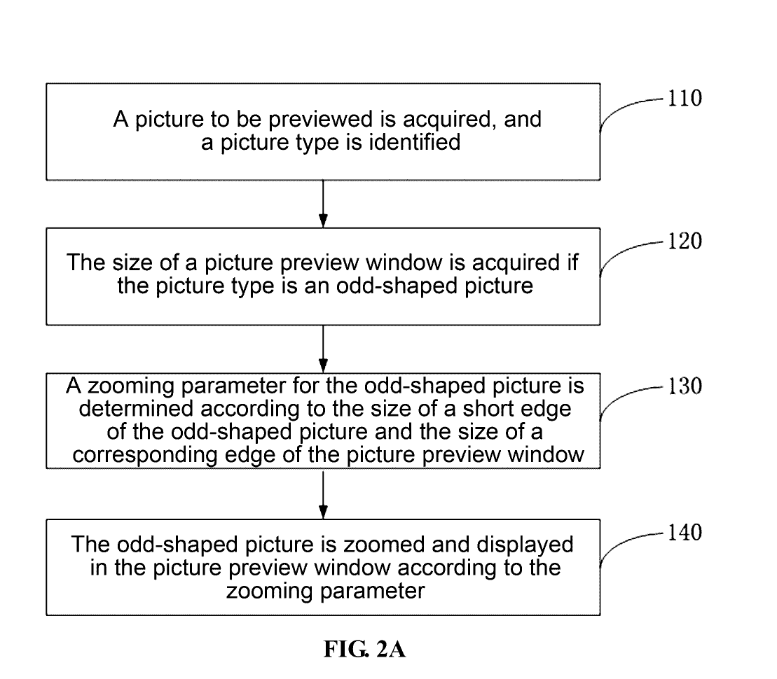

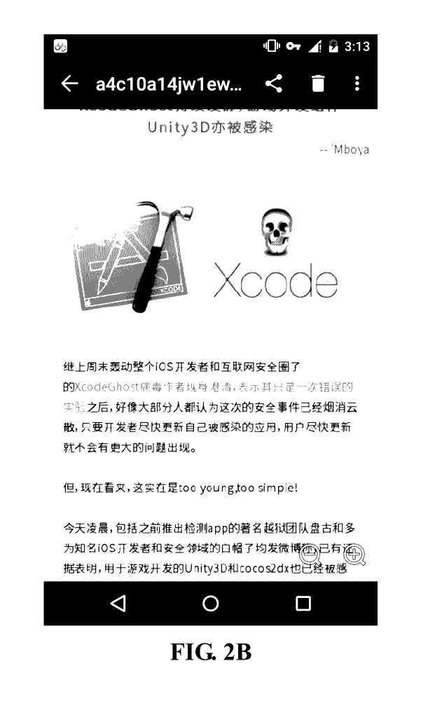

FIG. 2A is a schematic flow chart of a method for previewing a picture on an intelligent terminal according to Embodiment 1 of the application. The present embodiment may be applicable for the preview of an odd-shaped picture on an intelligent terminal, and the method for previewing a picture on an intelligent terminal may be executed by an electronic device for previewing a picture on an intelligent terminal. The device may be implemented in a hardware and/or software mode, and it may be generally integrated in an application end of the intelligent terminal.

The application end may be a plug-in unit of a client embedded in an intelligent terminal, or a plug-in unit of the operating system of the intelligent terminal, which is used in coordination with a picture preview-type client (for example, a picture browser) embedded in the intelligent terminal; the application end may also be an independent client that can provide a picture preview service in the intelligent terminal, which will not be limited in the present embodiment.

Referring to FIG. 2A, a method for previewing a picture on an intelligent terminal according to the present embodiment may include:

Step 110: a picture to be previewed is acquired, and a picture type is identified;

In the present embodiment, a picture to be previewed may be acquired by performing an interactive operation (for example, clicking on a hyperlink or a thumbnail, etc.) with an intelligent terminal on a specified picture that is to be previewed. Optionally, after receiving a message triggered by the user operation, the picture browser acquires the corresponding picture to be previewed.

After acquiring the picture to be previewed, the picture type is identified at the beginning. Optionally, the picture type may include a common picture and an odd-shaped picture. The common picture refers to a picture of which a size fits the screen of the intelligent terminal or fits the picture preview window of a picture preview tool configured in the intelligent terminal, for example, a photo captured by the intelligent terminal device via a camera, or a picture acquired by the intelligent terminal via screen shot. The odd-shaped picture refers to a picture with a size that is largely different from the screen of the intelligent terminal or the picture preview window of a picture browse tool configured in the intelligent terminal, for example, a long picture acquired by the intelligent terminal via network download or Bluetooth transmission, etc., or a panoramic photo acquired by the intelligent terminal via camera shoot or network download, etc.

Optionally, the above two types of pictures may be distinguished according to a relation between the length-to-width ratio of the picture and a specified threshold. A picture with a length-to-width ratio greater than the specified threshold is identified as a common picture, and a picture with a length-to-width ratio less than the specified threshold is identified as an odd-shaped picture. Wherein, the selection of the specified threshold may be preset according to practical situation (for example, it may be preset by referring to the length-to-width ratio of the screen of a current mainstream intelligent terminal or the length-to-width ratio of a long picture that is popular on the network), which is not limited in the present embodiment.

It should be noted that, according to the arrangement mode of the picture content, the odd-shaped picture may be further divided into a horizontal odd-shaped picture and a vertical odd-shaped picture. When a reader normally reads a picture content, a picture with its long edge placed in the horizontal direction is a horizontal odd-shaped picture, such as the above panoramic photo; and a picture with its long edge placed in the vertical direction is a vertical odd-shaped picture, such as the above long picture.

Optionally, the type of the picture to be previewed may be identified by acquiring the attribute information of the picture or the size information of the picture.

Step 120: the size of a picture preview window is acquired if the picture type is an odd-shaped picture;

Generally, the content of an odd-shaped picture is abundant, containing a large amount of literal or graphic information. In order to conveniently read the picture information by a mobile terminal user, the odd-shaped picture needs to be zoomed by a reasonable ratio so that after zooming, the content of the odd-shaped picture which is displayed on a picture preview window is easy to read. Thus, it may be seen that, the zooming of an odd-shaped picture takes the size of the picture preview window as a reference. Therefore, after it is determined that the picture to be previewed is an odd-shaped picture, the size of the picture preview window is acquired so as to obtain the above reasonable ratio for zooming the odd-shaped picture.

Step 130: a zooming parameter for the odd-shaped picture is determined according to the size of a short edge of the odd-shaped picture and the size of a corresponding edge of the picture preview window.

The size of the long edge of the odd-shaped picture is much larger than the size of the short edge thereof, and hence only a part of the contents of the readable odd-shaped picture is displayed on the preview window. In order to read the picture content conveniently by a user and avoid the scroll operation in two directions when reading the picture content, the short edge of the odd-shaped picture becomes a limiting factor for zooming an odd-shaped picture.

Generally, the larger the font on a picture is, the more easily a reader reads. That is, the odd-shaped picture is zoomed under the premise that the readability of the odd-shaped picture is guaranteed. When the short edge of the odd-shaped picture after zooming is equal to the length of the corresponding edge of the picture preview window, the readability is the best, as shown in FIG. 2B.

Optionally, the determining a zooming parameter for the odd-shaped picture according to the size of a short edge of the odd-shaped picture and the size of a corresponding edge of the picture preview window may include the following steps of determining the size of an edge of the picture preview window corresponding to the short edge; calculating a ratio of the size of the short edge of the odd-shaped picture to the size of the corresponding edge of the picture preview window; and taking the ratio as the zooming ratio of the odd-shaped picture.

During the practical reading process, the condition is met as long as a reader can clearly see the content information of the picture easily. Therefore, the size of the odd-shaped picture after zooming is not limited to that the short edge of the odd-shaped picture is equal to the corresponding edge of the picture preview window, but also the short edge of the odd-shaped picture may be zoomed to slightly less than the length of the corresponding edge of the picture browser window. Then, a zooming parameter for the odd-shaped picture is determined according to the obtained ratio of the length of the short edge of the odd-shaped picture to the length of the corresponding edge of the picture preview window.

It should be noted that, for a horizontal odd-shaped picture, the edges of the picture preview window corresponding to the short edge of the horizontal odd-shaped picture are two edges in the vertical direction. For a vertical odd-shaped picture, the edges of the picture preview window corresponding to the short edge of the vertical odd-shaped picture are two edges in the horizontal direction.

Step 140: the odd-shaped picture is zoomed and displayed in the picture preview window according to the zooming parameter;

The odd-shaped picture is zoomed in equal proportion according to the zooming parameter, that is, the length and width of the odd-shaped picture are both zoomed correspondingly according to the zooming ratio, and then the odd-shaped picture after zooming is displayed in the picture preview window.

In the technical solution according to this embodiment, after a picture to be previewed is identified, a zooming parameter for the odd-shaped picture is determined according to the size of the short edge of the odd-shaped picture and the size of the corresponding edge of the picture preview window, and the odd-shaped picture is zoomed and displayed in the picture preview window according to the zooming parameter, thereby solving the problem of poor readability of the information of the odd-shaped picture caused by unsuitable display ratio, improving the readability of the odd-shaped picture, and raising and user reading experience.

On the basis of the above embodiment, after the zooming and displaying the odd-shaped picture on the picture preview window according to the zooming parameter, the method may further include: exhibiting a visualized identification of a scroll browse picture in the picture preview window.

The content of the odd-shaped picture after zooming cannot be fully displayed on the preview window, so that it needs to be scrolled along the long edge of the odd-shaped picture for content switching. In the present embodiment, a visualized identification is provided on the picture preview window for prompting a user that the picture viewed currently belongs to an odd-shaped picture, and the user may know the scroll reading direction by setting the attribute, such as shape and the like, of the visualized identification. For example, for a vertical odd-shaped picture, and a scroll bar or a virtual button with a direction indicator may be added to the right of the picture preview window.

With the above settings, the reading direction and the content switching method of the odd-shaped picture may be prompted rapidly and effectively, thus improving the readability of the odd-shaped picture and the user reading experience.

### Embodiment 2

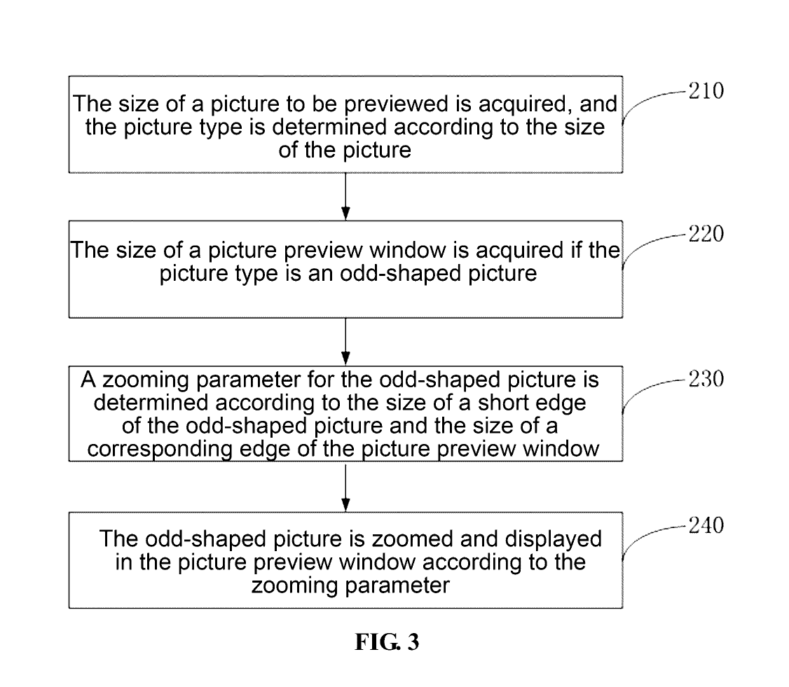

Based on the above Embodiment 1, the present embodiment provides a method for previewing a picture on an intelligent terminal. FIG. 3 is a schematic flow chart of a method for previewing a picture on an intelligent terminal according to Embodiment 2 of the application. As shown in FIG. 3, the method for previewing a picture on an intelligent terminal according to this embodiment may include:

Step 210: the size of a picture to be previewed is acquired, and a picture type is determined according to the size of the picture;

Optionally, the acquiring the size of the picture to be previewed and determining a picture type according to the size of the picture may include the following steps: a length size and a width size of the picture to be previewed is acquired; and it is determined that the picture type of the picture is an odd-shaped picture if a ratio of the length to the width is in a set value range.

In the present embodiment, the type of the picture to be previewed is determined according to the picture size. First of all, a picture browser acquires a length size and a width size of the picture to be previewed. Optionally, if the intelligent terminal is installed with an Android operating system, by invoking the class Option of BitmapFactory built in the Android system and setting the option in JustDecodeBounds in the class Option as “True”, the size and the aspect ratio of the picture to be previewed may be acquired during the decoding of the picture. Then, according to the length-to-width ratio of the picture to be previewed, it is judged whether the ratio is in a set value range. It should be noted that, usually a threshold may be set, and it is determined whether the picture is an odd-shaped picture by directly comparing the calculated ratio with the threshold.

The inventors find by researches that, if the threshold is set too small, many long pictures may be wrongly judged as common pictures, and if the threshold is set too large, a picture originally zoomed normally will be abnormal. Therefore, for the selection of a suitable threshold, it needs to guarantee that the reading experience will not be too poor even if a normal picture is zoomed as a long picture or a long picture is zoomed as a normal picture. In consideration of the above conditions and by investigating through selecting some long pictures (i.e., vertical odd-shaped pictures) from Microblog and Wechat as samples, ⅓ is finally selected as the threshold for distinguishing between common pictures and odd-shaped pictures.

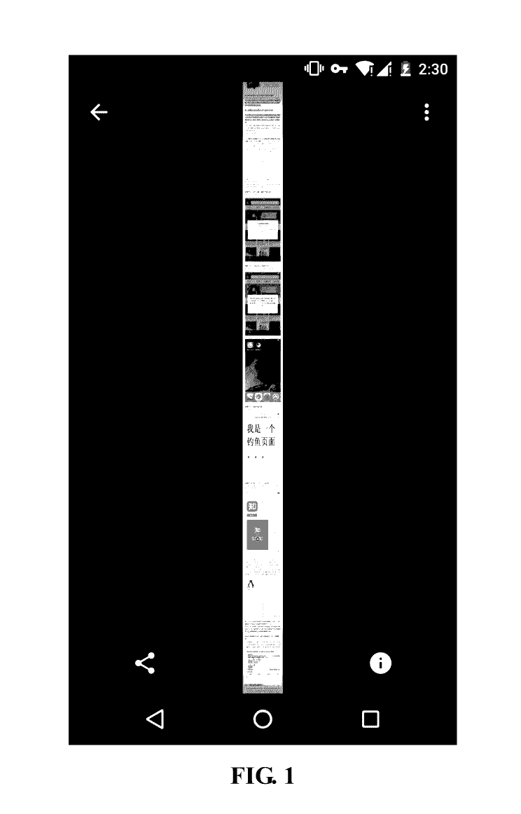

That is, if the ratio of the length to the width of the picture to be previewed is less than or equal to one-third, it is determined that the picture to be previewed is an odd-shaped picture. Exemplarily, the ratio of the length to the width of the picture shown in FIG. 1 is less than one-third.

However, it may be understood that, the threshold for determining whether a picture to be previewed is a long picture is not limited to the above one-third, and it may also be other values and may be adjusted by a user, which is not limited in the present embodiment.

Step 220: the size of a picture preview window is acquired if the picture type is an odd-shaped picture;

Step 230: a zooming parameter for the odd-shaped picture is determined according to the size of a short edge of the odd-shaped picture and the size of a corresponding edge of the picture preview window; and

Step 240: the odd-shaped picture is zoomed and displayed in the picture preview window according to the zooming parameter.

In the technical solution according to the present embodiment, the size of a picture to be previewed is acquired, a length-to-width ratio is calculated according to the size, and it is determined that the picture to be previewed is an odd-shaped picture when it is judged that the ratio is in a set value rang, and a zooming parameter is determined, then the odd-shaped picture is zoomed and displayed in the picture preview window according to the zooming parameter, so that the picture type may be identified via the picture size, and a targeted zooming process may be performed on the identified odd-shaped picture, thereby solving the problem of poor readability of the information of the odd-shaped picture caused by unsuitable display ratio, improving the readability of the odd-shaped picture, and raising user reading experience.

On the basis of the above embodiment, after the zooming and displaying the odd-shaped picture in the picture preview window according to the zooming parameter, the method may further include the following steps: if the odd-shaped picture exits preview, the browse location of the odd-shaped picture in the picture preview window at the time of exiting preview is saved and a correspondence between the browse location and the odd-shaped picture is established; and the zooming parameter for the odd-shaped picture is saved.

Correspondingly, after acquiring the picture to be previewed, the method further includes the following steps: if it is searched that the corresponding browse location and zooming parameter of the picture to be previewed are stored locally, the picture to be previewed is displayed on the picture preview window according to the browse location and the zooming parameter.

Because the volume of the information of an odd-shaped picture is large, in many cases, the content of the odd-shaped picture cannot be read in one time, thus in the present embodiment, it will be set differently when the odd-shaped picture is opened for the first time and when the odd-shaped picture is opened again, respectively.

If the picture browser judges that no related information of the current odd-shaped picture is stored locally, it is determined that the current odd-shaped picture is previewed for the first time. When the odd-shaped picture is opened for the first time, the user tends to read the picture information from the beginning. In the present embodiment, after the current odd-shaped picture is zoomed according to the obtained zooming parameter, the upper edge of the current odd-shaped picture (a vertical odd-shaped picture) or the left edge of the current odd-shaped picture (a horizontal odd-shaped picture) is identified, and when the current odd-shaped picture is displayed in the picture preview window, the upper edge (vertical odd-shaped picture) or the left edge (horizontal odd-shaped picture) is made to coincide with the upper edge (vertical odd-shaped picture) or the left edge (horizontal odd-shaped picture) of the picture preview window.

If the picture browser judges that the related information of the current odd-shaped picture is stored locally, it determined that the current odd-shaped picture is previewed again. When the odd-shaped picture is opened again, the user tends to continue with the information unread in last time; as directed to such a problem, in the present embodiment, when the odd-shaped picture exits preview, the current reading location information and the zooming parameter are saved, so that when the picture is opened again, the corresponding content can be displayed in the preview window directly according to the saved zooming parameter and the saved location information.

As directed to the problem that the volume of the information of the odd-shaped picture is large and hence the user may not read the full content in the odd-shaped picture in one time, a correspondence between the user's last browse location and the odd-shaped picture is established, and the zooming parameter for the odd-shaped picture is saved, so that when the user opens the odd-shaped picture again, it does not need to recalculate the zooming parameter for the odd-shaped picture, and the odd-shaped picture can be rapidly adjusted to a suitable size for the user to read; also, by jumping the current display location of the odd-shaped picture to the user's last browse location, it may be avoided that the user manually switches the content that has been read, thus improving the user reading experience.

### Embodiment 3

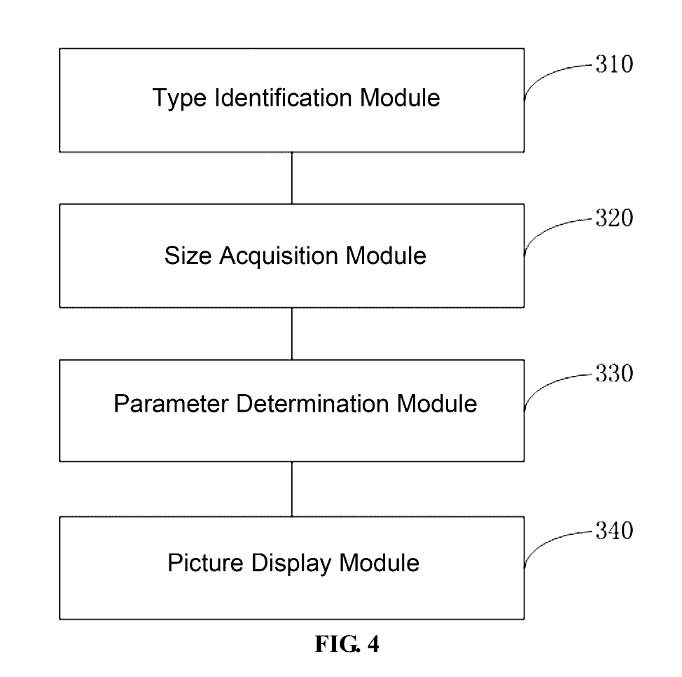

FIG. 4 is a structural representation of an apparatus for previewing a picture in an intelligent terminal according to Embodiment 4 of the application. The apparatus for previewing a picture on an intelligent terminal according to the present embodiment may be set in a picture browser of the intelligent terminal. Referring to FIG. 4, the structure of the apparatus for previewing a picture on an intelligent terminal includes:

a type identification module 310, a size acquisition module 320, a parameter determination module 330 and a picture display module 340.

The type identification module 310 is configured for acquiring a picture to be previewed and identifying a picture type;

The size acquisition module 320 is configured for acquiring the size of a picture preview window when it is determined that the picture type is an odd-shaped picture;

The parameter determination module 330 is configured for determining a zooming parameter for the odd-shaped picture according to the size of a short edge of the odd-shaped picture and the size of a corresponding edge of the picture preview window; and

The picture display module 340 is configured for zooming and displaying the odd-shaped picture in the picture preview window according to the zooming parameter.

In the technical solution according to this embodiment, after a picture to be previewed is identified, a zooming parameter for the odd-shaped picture is determined according to the size of the short edge of the odd-shaped picture and the size of the corresponding edge on the picture preview window, and the odd-shaped picture is zoomed and displayed in the picture preview window according to the zooming parameter, thereby solving the problem of poor readability of the information of the odd-shaped picture caused by unsuitable display ratio, improving the readability of the odd-shaped picture, and raising user reading experience.

On the basis of the above embodiment, the type identification module 310 may include:

a type determination unit, configured for acquiring the size of the picture to be previewed and determining the picture type according to the size of the picture.

On the basis of the above embodiment, the type determination unit may include:

an information acquisition subunit, configured for acquiring a length size and a width size of the picture to be previewed; and

a range comparison subunit, configured for determining that the picture type of the picture is an odd-shaped picture when it is judged that the ratio of the length to the width is in a set value range.

On the basis of the above embodiment, the range comparison subunit may be configured for:

determining that the picture is a long picture if the ratio of the length to the width is less than or equal to one-third.

In the present embodiment, the parameter determination module 330 may include:

a size determination unit, configured for determining the size of an edge of the picture preview window corresponding to the short edge;

a ratio calculation unit, configured for calculating a ratio of the size of the short edge of the odd-shaped picture to the size of the corresponding edge of the picture preview window; and

a ratio determination unit, configured for taking the ratio as the zooming ratio of the odd-shaped picture.

On the basis of the above embodiment, the apparatus may further include:

an identification exhibition module, configured for exhibiting a visualized identification of a scroll browse picture in the picture preview window after zooming and displaying the odd-shaped picture in the picture preview window according to the zooming parameter.

On the basis of the above embodiment, the apparatus may further include:

a location saving module, configured for, after zooming and displaying the odd-shaped picture in the picture preview window according to the zooming parameter, saving, if the odd-shaped picture exits preview, the browse location of the odd-shaped picture in the picture preview window at the time of exiting preview, and establishing a correspondence between the browse location and the odd-shaped picture; and

a parameter saving module, configured for saving the zooming parameter for the odd-shaped picture.

Correspondingly, the apparatus may further include:

a picture preview module, configured for, after acquiring the picture to be previewed, displaying, if it is searched that the corresponding browse location and zooming parameter of the picture to be previewed are stored locally, the picture to be previewed in the picture preview window according to the browse location and the zooming parameter.

The electronic device for previewing a picture on an intelligent terminal according to this embodiment belongs to the same inventive concept as the method for previewing a picture on an intelligent terminal according to any embodiment of the application, it may execute the method for previewing a picture on an intelligent terminal according to any embodiment of this application, and it may have the corresponding functional modules and beneficial effects. For the technical details not described in detail in the present embodiment, reference may be made to the picture preview process of an intelligent terminal according to any embodiment of this application.

### Embodiment 4

The present embodiment of the present application provides a non-transitory computer storage medium on which computer-executable instructions are stored, wherein the computer-executable instructions are configured for executing the method for previewing a picture on an intelligent terminal according to any of the above method embodiments.

### Embodiment 5

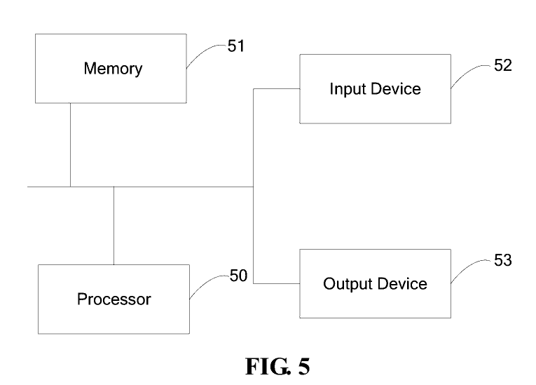

FIG. 5 is a schematic diagram showing the hardware structure of an electronic device for executing a method for previewing a picture on an intelligent terminal according to Embodiment 5 of the application. Referring to FIG. 5, the electronic device includes:

one or more processors 50 and a memory 51; FIG. 5 shows an example in which the device includes one processor 50.

The device may further include: an input device 52 and an output device 53. The processor 50, the memory 51, the input device 52 and the output device 53 in the device may be connected via a bus or in other manners. FIG. 5 shows an example in which they are connected via a bus.

As a non-transitory computer-readable storage medium, the memory 51 may be configured for storing a non-transitory software program, a non-transitory computer-executable program and a module, such as the program instruction/module corresponding to the method for previewing a picture in the embodiments of the disclosure (for example, the image acquisition module 40, the region identification module 41, the decision point determination module 42, the white balance parameter adjustment module 43 and the image adjustment module 44 shown in FIG. 4). The processor 50 executes the functional application and data processing of a server by running the software programs, instructions and modules stored in the memory 51, thereby implementing the method for previewing a picture according to the above method embodiments.

The memory 51 may include a program storage region and a data storage region, where, the program storage region may be configured for storing an operating system and at least one functional application program; and the data storage region may be configured for storing the data created according to the use of a terminal device, etc. Additionally, the memory 51 may include a high random access memory, or it may further include a non-transitory memory, for example, at least one disk storage apparatus, flash memory apparatus or other non-transitory solid-state memory apparatuses. In some examples, the memory 51 may include a memory set remotely relative to the processor 50, and such a remote memory may be connected to a terminal device via a network. An example of the above network includes, but is not limited to, Internet, Intranet, Local Area Network (LAN), Mobile Communication Network and a combination thereof.

The input device 52 may be configured for receiving the inputted digit or character information and generating a key signal input related to the user setting and function control of the terminal. The output device 53 may include a display device, such as a display screen.

The one or more modules are stored in the memory 51. When executed by the one or more processors 50, the one or more modules will perform the steps of the method for previewing a picture according to any of the above method embodiments.

The above product may perform the method according to the embodiments of the disclosure, and it may have the corresponding functional modules and beneficial effects of the method performed. For the technical details that are not described fully in this embodiment, reference may be made to the method provided in the present embodiments of the disclosure.

The electronic equipment in embodiments of this application exists in various forms, including but not limited to:

(1) Mobile Telecommunication Device. A device of this kind has a feature of mobile communicating function, and has a main object of providing voice and data communication. Devices of this kind include smart phone (such as iPhone), multi-media cell phone, functional cell phone, low-end cell phone and the like;

(2) Ultra Mobile Personal Computer Device. A device of this kind belongs to a category of personal computer, has functions of computing and processing, and generally has a feature of mobile Internet access. Devices of this kind include PDA, MID, UMPC devices and the like, such as ipad;

(3) Portable Entertainment Device. A device of this kind can display and play multi-media content. Devices of this kind include audio and video player (such as ipod), handheld game player, e-book, intelligent toy and portable vehicle navigation device;

(4) Server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) Other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement do not make essential of corresponding technical solutions depart from spirits and scope of technical solutions of various embodiments.

What is claimed is:

1. A method for previewing a picture on an intelligent terminal, which is applied to an intelligent terminal, comprising:
acquiring a picture to be previewed, and identifying a picture type;
acquiring the size of a picture preview window if the picture type is an odd-shaped picture;
determining a zooming parameter for the odd-shaped picture according to the size of a short edge of the odd-shaped picture and the size of a corresponding edge of the picture preview window; and
zooming and displaying the odd-shaped picture in the picture preview window according to the zooming parameter.

2. The method according to claim 1, wherein, the acquiring a picture to be previewed and identifying a picture type comprises:
acquiring the size of the picture to be previewed, and determining the picture type according to the size of the picture.

3. The method according to claim 2, wherein, the acquiring the size of the picture to be previewed and determining the picture type according to the size of the picture comprises:
acquiring a length size and a width size of the picture to be previewed; and
determining that the picture type of the picture is an odd-shaped picture if a ratio of the length to the width is in a set value range.

4. The method according to claim 3, wherein, the determining that the picture type of the picture is an odd-shaped picture if a ratio of the length to the width is in a set value range comprises:
determining that the picture is a long picture if the ratio of the length to the width is less than or equal to one-third.

5. The method according to claim 1, wherein, the determining a zooming parameter for the odd-shaped picture according to the size of a short edge of the odd-shaped picture and the size of a corresponding edge of the picture preview window comprises:
determining the size of an edge of the picture preview window corresponding to the short edge;
calculating a ratio of the size of the short edge of the odd-shaped picture to the size of the corresponding edge of the picture preview window; and
taking the ratio as the zooming ratio of the odd-shaped picture.

6. The method according to claim 1, wherein, after the zooming and displaying the odd-shaped picture in the picture preview window according to the zooming parameter, the method further comprises:
exhibiting a visualized identification of a scroll browse picture in the picture preview window.

7. The method according to claim 1, wherein, after the zooming and displaying the odd-shaped picture in the picture preview window according to the zooming parameter, the method further comprises:
saving, if the odd-shaped picture exits preview, the browse location of the odd-shaped picture in the picture preview window at the time of exiting preview, and establishing a correspondence between the browse location and the odd-shaped picture; and
saving the zooming parameter for the odd-shaped picture;
wherein after acquiring the picture to be previewed, the method further comprises: displaying, if it is searched that the corresponding browse location and zooming parameter of the picture to be previewed are stored locally, the picture to be previewed in the picture preview window according to the browse location and the zooming parameter.

8. A non-transitory computer storage medium storing computer-executable instructions that, when executed by an electronic device, cause the electronic device to:
acquire a picture to be previewed, and identify a picture type;
acquire the size of a picture preview window if the picture type is an odd-shaped picture;
determine a zooming parameter for the odd-shaped picture according to the size of a short edge of the odd-shaped picture and the size of a corresponding edge of the picture preview window; and
zoom and display the odd-shaped picture in the picture preview window according to the zooming parameter.

9. The non-transitory computer storage medium according to claim 8, wherein, the to acquire a picture to be previewed and identifying a picture type comprises:
acquire the size of the picture to be previewed, and determine the picture type according to the size of the picture.

10. The non-transitory computer storage medium according to claim 9, wherein, the to acquire the size of the picture to be previewed and determine the picture type according to the size of the picture comprises:
acquire a length size and a width size of the picture to be previewed; and
determine that the picture type of the picture is an odd-shaped picture if a ratio of the length to the width is in a set value range.

11. The non-transitory computer storage medium according to claim 10, wherein, the to determine that the picture type of the picture is an odd-shaped picture if a ratio of the length to the width is in a set value range that comprises:
determine that the picture is a long picture if the ratio of the length to the width is less than or equal to one-third.

12. The non-transitory computer storage medium according to claim 8, wherein, the to determine a zooming parameter for the odd-shaped picture according to the size of a short edge of the odd-shaped picture and the size of a corresponding edge of the picture preview window comprises:
determine the size of an edge of the picture preview window corresponding to the short edge;
calculate a ratio of the size of the short edge of the odd-shaped picture to the size of the corresponding edge of the picture preview window; and
taking the ratio as the zooming ratio of the odd-shaped picture.

13. The non-transitory computer storage medium according to claim 8, wherein, after zoom and display the odd-shaped picture on the picture preview window according to the zooming parameter, the execution of the instructions further causes the electronic device to:
exhibit a visualized identification of a scroll browse picture in the picture preview window.

14. The non-transitory computer storage medium according to claim 8, wherein, after zoom and display the odd-shaped picture in the picture preview window according to the zooming parameter, the execution of the instructions further causes the electronic device to:
save, if the odd-shaped picture exits preview, the browse location of the odd-shaped picture in the picture preview window at the time of exiting preview, and establish a correspondence between the browse location and the odd-shaped picture; and
save the zooming parameter for the odd-shaped picture;
wherein, after acquire the picture to be previewed, the execution of the instructions further causes the electronic device to: display, if it is searched that the corresponding browse location and zooming parameter of the picture to be previewed are stored locally, the picture to be previewed in the picture preview window according to the browse location and the zooming parameter.

15. An electronic device for previewing a picture on an intelligent terminal, comprising:
at least one processor; and
a memory communicably connected with the at least one processor for storing instructions executable by the at least one processor, wherein execution of the instructions by the at least one processor causes the at least one processor to:
acquire a picture to be previewed, and identify a picture type;
acquire the size of a picture preview window if the picture type is an odd-shaped picture;
determine a zooming parameter for the odd-shaped picture according to the size of a short edge of the odd-shaped picture and the size of a corresponding edge of the picture preview window; and
zoom and display the odd-shaped picture in the picture preview window according to the zooming parameter.

16. The electronic device according to claim 15, wherein, the to acquire a picture to be previewed and identify the picture type comprises:
acquire the size of the picture to be previewed, and determine the picture type according to the size of the picture.

17. The electronic device according to claim 16, wherein, the to acquire the size of the picture to be previewed and determine the picture type according to the size of the picture comprises:
acquire a length size and a width size of the picture to be previewed; and
determine that the picture type of the picture is an odd-shaped picture if a ratio of the length to the width is in a set value range.

18. The electronic device according to claim 17, wherein, the to determine that the picture type of the picture is an odd-shaped picture if a ratio of the length to the width is in a set value range comprises:
determine that the picture is a long picture if the ratio of the length to the width is less than or equal to one-third.

19. The electronic device according to claim 15, wherein, the to determine a zooming parameter for the odd-shaped picture according to the size of a short edge of the odd-shaped picture and the size of a corresponding edge of the picture preview window comprises:
determine the size of an edge of the picture preview window corresponding to the short edge;
calculate a ratio of the size of the short edge of the odd-shaped picture to the size of the corresponding edge of the picture preview window; and
taking the ratio as the zooming ratio of the odd-shaped picture.

20. The electronic device according to claim 15, wherein, after zoom and display the odd-shaped picture on the picture preview window according to the zooming parameter, the execution of the instructions further causes the processor to:
save, if the odd-shaped picture exits preview, the browse location of the odd-shaped picture on the picture preview window at the time of exiting preview, and establish a correspondence between the browse location and the odd-shaped picture; and
save the zooming parameter for the odd-shaped picture;
wherein, after acquire the picture to be previewed, the execution of the instructions further causes the processor to: display, if it is searched that the corresponding browse location and zooming parameter of the picture to be previewed are stored locally, the picture to be previewed in the picture preview window according to the browse location and the zooming parameter.
